(19) United States
(12) Patent Application Publication
(10) Pub. No.: US 2004/0028130 A1
(43) Pub. Date: Feb. 12, 2004

(54) Video encoder

(76) Inventors: Anthony Richard May, Winchester (GB); Paola Marcella Hobson, Basingstoke (GB); Kevin Michael McKoen, Bishops Sutton (GB)

Correspondence Address: MOTOROLA, INC., 1303 EAST ALGONQUIN ROAD, IL01/3RD, SCHAUMBURG, IL, 60196

(21) Appl. No.: 10/429,520

(22) Filed: May 5, 2003

Related U.S. Application Data
(63) Continuation-in-part of application No. 09/447,073, filed on Nov. 22, 1999, now abandoned.

(30) Foreign Application Priority Data
May 24, 1999 (GB) 9912082.6

(51) Int. Cl. H04N 7/12

(52) U.S. Cl. 375/240.08; 382/173

(57) ABSTRACT

A video encoder (300) for compressing and encoding frames of an image sequence for transmission and a method of video encoding. The video encoder (300) has segmentation means (322) for recognising at least one object (450) in a frame (400) of an image sequence, and an encoder (304) for encoding blocks of the image sequence into a single bitstream for transmission, wherein blocks containing the at least one object being transmitted preferentially over other blocks. The segmentation means (322) may operate under user control (324). The video encoder (300) may be made compatible with the H.263 standard, whereby a standard H.263 receiver can then decompress and decode the transmitted image sequence. The invention may be incorporated into a mobile or a portable radio, or a mobile telephone.

### CROSS-REFERENCE TO RELATED APPLICATIONS

This application is a continuation in part of copending U.S. patent application Ser. No. 09/447,073 filed Nov. 22, 1999 for Video Encoder (herein referred to as ‘the parent application’).

### TECHNICAL FIELD

The present invention relates to the field of video encoders. In particular, the present invention relates to video encoders for compressing and encoding frames of an image sequence for transmission.

### BACKGROUND

A video encoder can be used to encode one or more frames of an image sequence into digital information. This digital information may then be transmitted to a receiver, where the image or the image sequence can then be re-constructed.

Various international standards have been agreed for video encoding and transmission. In general, these standards provide rules for compressing and encoding data relating to frames of an image. These rules provide a way of compressing and encoding image data to provide less data than the viewing camera originally provided about the image. This reduced volume of data then requires less channel bandwidth for transmission. A receiver can re-construct the image from the transmitted data if it knows the rules that the transmitter used to perform the compression and encoding.

One of the international standards for video encoding is the ITU-T ‘Recommendation H.263’. In particular, very low bit rate video encoders make use of the H.263 standard. Typically, video encoders down to bit rates of 8 kbit/second use the H.263 standard, although lower bit rates are possible with this standard. The H.263 standard is considered to be the current state of the art in video compression technology.

An image sequence representing a two-dimensional image, e.g. as obtained from a conventional video camera, consists of consecutive ‘still’ images, called frames. H.263 can use a frame size of 176 by 144 pixels. This is the Quarter Common Intermediate format or ‘QCIF’ frame. This is illustrated as frame 100 in appended FIG. 1.

The H.263 standard specifies that each frame is divided into macroblocks. Each macroblock relates to 16 pixels by 16 lines of Y and the spatially corresponding 8 pixels by 8 lines of CB and CR. A macroblock in fact consists of four luminance blocks and the two spatially corresponding colour difference blocks.

Each luminance block has a size of 8 by 8 pixels. This sub-division into blocks and macro-blocks has also been shown in the QCIF frame of FIG. 1. Elements 110, 112, 114 and 116 of FIG. 1 are luminance blocks. Blocks 110, 112, 114 and 116, together with two colour difference blocks not shown on FIG. 1, constitute a single macroblock.

As explained above, the macroblock in FIG. 1 also comprises two further blocks, which are not shown on FIG. 1. These further blocks carry chrominance information. Each chrominance block carries information about all four of the blocks shown in FIG. 1. The chrominance information is represented with half the vertical and horizontal resolution of the luminance part of the image.

Therefore a macroblock consists of six blocks, four of which comprise luminance information, the other two comprising chrominance information about the four luminance blocks.

The blocks are transformed and quantised, to generate a texture map. This means that the individual pixels of each block are converted into a digital data value. These data values are then efficiently coded into a H.263 bitstream for transmission. In a typical practical application, a user may wish to transmit to a receiver either a single frame of a two-dimensional image, or an image sequence comprising many frames. The H.263 bitstream is ideal for such transmission. The transmission channel itself may for example be a radio link, a GSM mobile ‘phone TDMA channel or could be a fixed line telephone link.

Some parts of an image will not change from one image frame to the next. This might be the case for a security surveillance camera pointed constantly at an unchanging scene. If a macroblock does not change from one image to the next, then there is no need to transmit the data of that macroblock. The H.263 standard in fact allows a macroblock to be ‘skipped’, i.e. not transmitted, if it is unchanged from the previous frame.

From one frame to the next, a particular part of an image may show very little change, but simply move within the field of view of a camera. This might be the case, for example, for a ball moving across an otherwise stationary background. Macroblocks showing the ball may show little change in their pixels, but effectively translate across the field of view. In such a case, H.263 allows transmission of data indicating only the direction and amount of the movement, and data indicating the differences between the pixel values over those of the corresponding macroblock in the previous frame. The data indicating the direction and amount of the movement is referred to as a ‘motion vector’ for the macroblock. Transmitting this information requires far less data than transmitting an entire macroblock.

In the special case where the motion vector is zero and there is no change to the texture seen by the camera, no differences exist at all for the macroblock in comparison to the same macroblock in the previous frame. This is the situation explained above, under which the entire macroblock can be skipped without affecting the accuracy of the image received by a receiver.

In the usual terminology for H.263, transmission of the motion vector and differences values of a macroblock in place of an entire macroblock is referred to as transmission of an ‘INTER macroblock’. If however the entire macroblock is encoded and transmitted, this is referred to as transmission of an ‘INTRA macroblock’. H.263 contains the rule that an INTRA macroblock must be transmitted at least once every 132 frames, regardless of whether or not there has been any change to the pixels of that macroblock.

If all the macroblocks of an entire frame are encoded and transmitted, this is referred to as transmission of an ‘INTRA frame’. An INTRA frame therefore consists entirely of INTRA macroblocks. Typically, an INTRA frame must be transmitted at the start of an image transmission, when the receiver as yet holds no received macroblocks.

If a frame is encoded and transmitted by encoding some or all of the macroblocks as INTER macroblocks, then the frame is referred to as an ‘INTER frame’. Typically, an INTER frame comprises less data for transmission than an INTRA frame. However, the encoder decides whether a macroblock is transmitted as an INTRA or an INTER macroblock, depending on which is most efficient.

The H.263 standard thus avoids redundant transmission of parts of the image, by using motion compensated prediction of macroblocks from previous frames. This is a very important technique in systems in which the available bandwidth for transmission of the image sequence is limited, i.e. the transmission data rate is limited.

Current implementations of H.263 usually treat all parts of the image equally. These systems will only skip a macroblock in the bitstream if all the motion vectors and texture update values for that macroblock are zero. Some implementations do however give extra emphasis to the centre of the field of view of the camera, on the assumption that this is where the action occurs in which the viewer will be most interested.

Many systems have only a certain maximum data rate available on the transmission channel. This is the case, for example, for a portable or a mobile radio. Portable or mobile radios typically transmit the image over a ‘narrrowband’ radio link of limited bandwidth. This transmission will be to a base station or to another mobile or portable radio. In a video sequence containing a lot of motion or detail, a H.263 encoder in such a system has to reduce the frame encoding and transmission rate, or increase the quantisation of the texture map, in order to match the data rate output from the encoder to the date rate available on the radio link. Increasing the quantisation of the texture map will decrease the amount of data for transmission per frame of the image, but leads to a correspondingly lower image quality. This may appear as a coarseness or granularity in the received image.

Currently, rate control trade-offs are made using ad-hoc design rules or global user input parameters. These generally result in changes to an image simply causing the frame rate and resolution of the entire transmitted image to be reduced.

As an example, consider an image sequence of a tennis player moving around on a tennis court. In this example, consider also the image to include a crowd in the background, an umpire and other officials. Consider also such an image sequence being transmitted on a narrowband transmission link of severely limited maximum data rate. Using the H.263 protocol, any movement of the crowd, umpire and officials will need to be transmitted and will reduce the frame rate and resolution with which the entire image is transmitted, in dependence on the amount of movement. This will therefore cause degradation of the quality with which the image of the player and the ball are transmitted. This may be unsatisfactory for a viewer who receives the image, because the viewer is more likely to be interested in an accurate depiction of the player and the ball than of the officials and crowd.

FIG. 2 shows a prior art video encoder 200. Encoder 204 receives data about an image sequence from a camera 202. After compressing and encoding the data from the camera, the encoder 204 passes the information to a transmission circuit 206.

Another of the international standards for video encoding is the ‘ISO MPEG4’ standard. The ISO MPEG4 standard contains tools for individually coding video objects, their shape and their composition in an audio-visual scene. These object-based functionalities are targeted at high data rate systems (typically >64 kbps) and contain bitstream syntax overheads that would reduce the number of bits available for coding the video objects in a narrowband channel to an unacceptably low level.

In the MPEG4 system, a segmentation algorithm can select a particular object from an image sequence. The MPEG4 system then transmits details of this object in a special frame, containing just the object surrounded by a blank background. In parallel to this, the system has to send the remainder of the frame in which the object originated, with a ‘cutout’ where the object had been. The syntax to do this needs to be transmitted along with the frames, and the receiver clearly needs to be able to receive and decode this data. Furthermore, the blank background to the special frame containing the object has to be coded and transmitted. The syntax data and the blank background constitute extra data that needs to be transmitted, so the transmission of details of an object leads to an additional load on the transmission link. Although transmission over a 64 kbps link is not too severely degraded by this, the scheme is not suited to efficient transmission over a narrowband link. This scheme is not foreseen in H.263.

Explicitly coding any information about objects, e.g. shape, cannot be done using the H.263 standard, unlike in MPEG4, since the H.263 standard does not provide any method of doing so. Attempts to include such information in an H.263 encoder as an extra transmission of the type described above for MPEG4 would cause the encoder to be incompatible with other manufacturers' H.263 decoders. Thus adapting an H.263 video encoder to implement the ‘extra’ object transmission known from MPEG4 would produce a video encoder which is no longer compatible with other H.263 standard codecs.

U.S. Pat. No. 6,055,330, issued after the filing of the parent application, describes a system that produces video and depth stream data and wherein a segmentation procedure is applied to the depth stream only. The data stream produced in such a system is a complex representation of a three dimensional image. Such a system is a special system requiring a complex multi-camera imaging arrangement to obtain the three dimensional image data. It is not applicable for use to process data obtained from a two-dimensional image such as obtained from a conventional single video camera.

A need exists therefore to alleviate the problems of the prior art, particularly of video encoders for low data rate transmission of data representing a two dimensional image obtained from a conventional video camera.

### SUMMARY OF THE INVENTION

In accordance with the invention, a video encoder for compressing and encoding frames of an image sequence for transmission comprises segmentation means for receiving only a two dimensional image sequence and identifying at least one object in a frame of an image sequence, means for dividing a frame of an image sequence into blocks, means for selecting blocks containing the at least one object to provide selected blocks, and a bitstream encoder for encoding blocks of the image sequence into a single bitstream for transmission, wherein the selected blocks containing the at least one object are included in the bitstream preferentially over other blocks. The encoder may further include means for transmitting the bitstream containing the encoded blocks, whereby the selected blocks containing the at least one object are transmitted preferentially over other blocks.

The encoder according to the invention is operable to process data representing a two-dimensional video image which has been produced by a conventional commercially available video camera and which therefore does not include data relating to the depth of a scene , e.g. as envisaged in U.S. Pat. No. 6,055,030.

The means for dividing a frame of an image sequence into blocks may be adapted to divide a frame of the image sequence into macroblocks, each macroblock comprising chrominance and luminance information about a plurality of blocks, whereby macroblocks containing one or more selected blocks constitute selected macroblocks.

Also in accordance with the invention, a method of video encoding for compressing and encoding frames of a two-dimensional image sequence for transmission comprises segmenting a frame of an image sequence, thereby to recognise at least one object in the image sequence, dividing the frame of the image sequence into blocks, selecting blocks containing the at least one object to provide selected blocks, encoding blocks of the image sequence into a single bitstream for transmission, wherein the selected blocks containing the at least one object are included in the bitstream preferentially over other blocks. The method may further include transmitting the bitstream containing the encoded blocks, whereby the selected blocks containing the at least one object are transmitted preferentially over other blocks.

The method of video encoding may further comprise the step of dividing the frame of the image sequence into macroblocks, comprising chrominance and luminance information about a plurality of blocks, whereby macroblocks containing one or more selected blocks constitute selected macroblocks.

The invention beneficially provides enhanced frame and image sequence transmission for a two-dimensional video image, e.g. obtained from a conventional single video camera. It will also provide enhanced reception, particularly where the transmission link has significantly limited transmission bandwidth. The invention provides particular advantages in an image sequence transmission system for transmission by wireless communication in a portable or a mobile radio, or in a mobile telephone.

### BRIEF DESCRIPTION OF THE DRAWINGS

FIG. 1 shows a frame of an image sequence in accordance with the H.263 standard.

FIG. 2 is a block schematic diagram illustrating a prior art video encoder.

FIG. 3 is a block schematic diagram illustrating a video encoder in accordance with an embodiment of the present invention.

FIG. 4 shows a frame of an image sequence in accordance with an embodiment of the present invention.

### DETAILED DESCRIPTION OF THE PREFERRED EMBODIMENT

FIG. 3 illustrates a video encoder 300 in accordance with the present invention. The video encoder of FIG. 3 may function in accordance with the H.263 standard. Parts of FIG. 3, which correspond to those in FIG. 3, will not be discussed again in detail in connection with FIG. 3.

Video encoder 300 of FIG. 3 provides for compression and encoding of frames of an image sequence for transmission. Video encoder 300 comprises segmentation means 322 for recognising at least one object in a frame of an image sequence. Segmentation means 322 may be under user control through user interface means 324. The image sequence may, for example, be provided by a video camera 302.

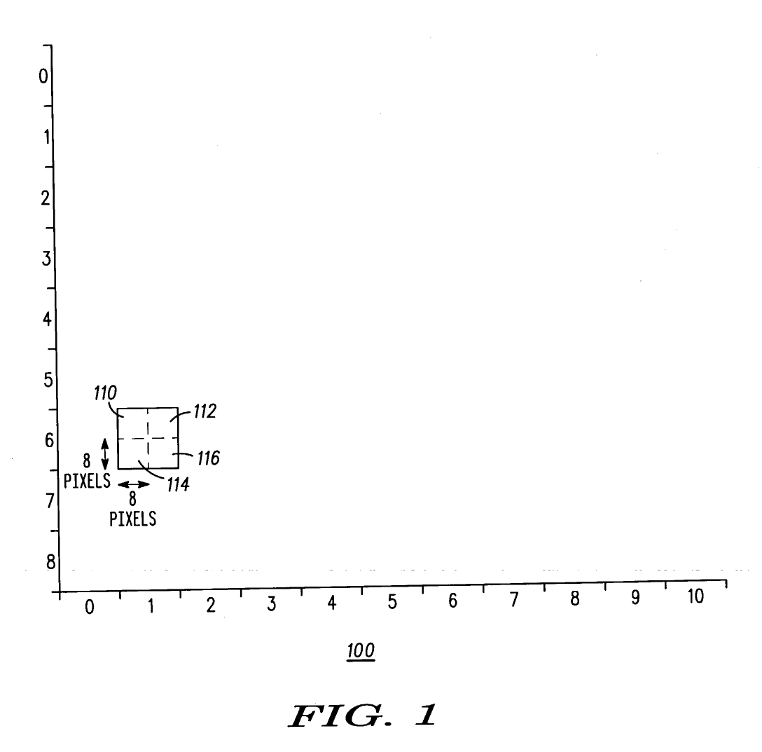

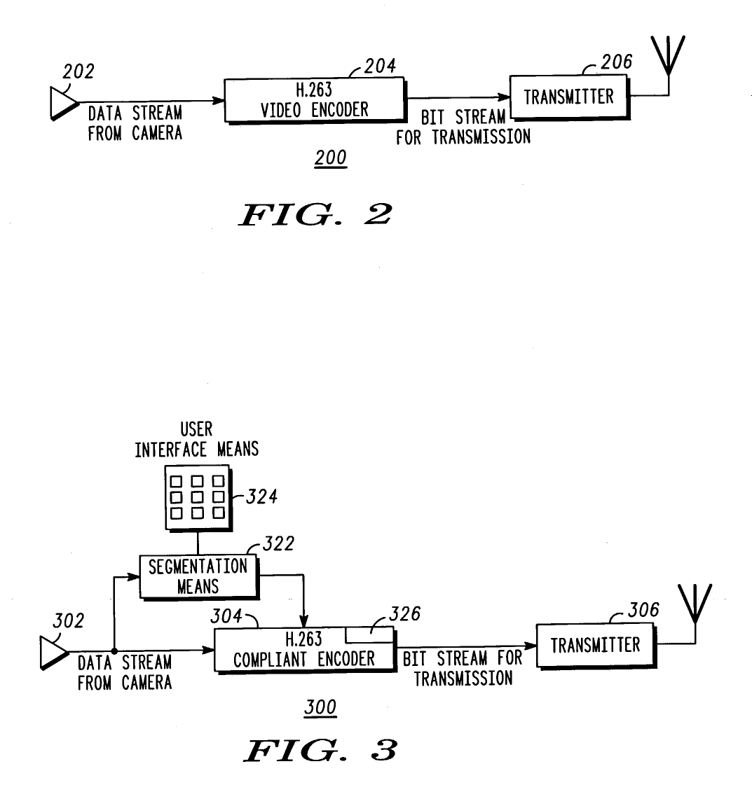

Video encoder 300 comprises means for dividing a frame of an image sequence into blocks. This function can be performed by encoder 304. The blocks of the image sequence correspond generally to those shown in FIG. 1 as elements 110, 112, 114 and 116.

Encoder 304 is adapted to select blocks containing the object or objects identified by segmentation means 322. Blocks containing the object or objects identified by segmentation means 322 constitute selected blocks. The invention allows these selected blocks to receive preferential treatment over blocks that do not contain the object or objects identified by segmentation means 322. This is a capability not provided in the H.263 standard.

The encoder 304 encodes blocks of the image sequence into a single bitstream for transmission. In the embodiment of the invention shown in FIG. 3, this bitstream is compatible with the H.263 standard, so can be received by a standard H.263 decoder. The bitstream generated by encoder 304 does not contain extra syntax bit overhead relating to the object or objects identified by segmentation means 322, unlike the MPEG4 encoding and transmission system.

Transmitter 306 transmits the bitstream containing the encoded blocks. In the case of the embodiment shown in FIG. 3, the transmission is via a radio link. The circuitry of FIG. 3 may, for example, form part of a mobile or a portable two-way radio, or a mobile phone.

The arrangement of FIG. 3 ensures that blocks containing the at least one object are transmitted preferentially over other blocks. This is achieved by the combination of object identification by segmentation means 322, and preferential encoding of blocks containing the object(s) by encoder 304.

Encoder 304 may divide a frame of an image sequence into blocks and macroblocks. Each macroblock comprises chrominance and luminance information about a plurality of blocks. Analogously to the definition of ‘selected blocks’ used above, a macroblock containing one or more selected blocks constitutes a ‘selected macroblock’.

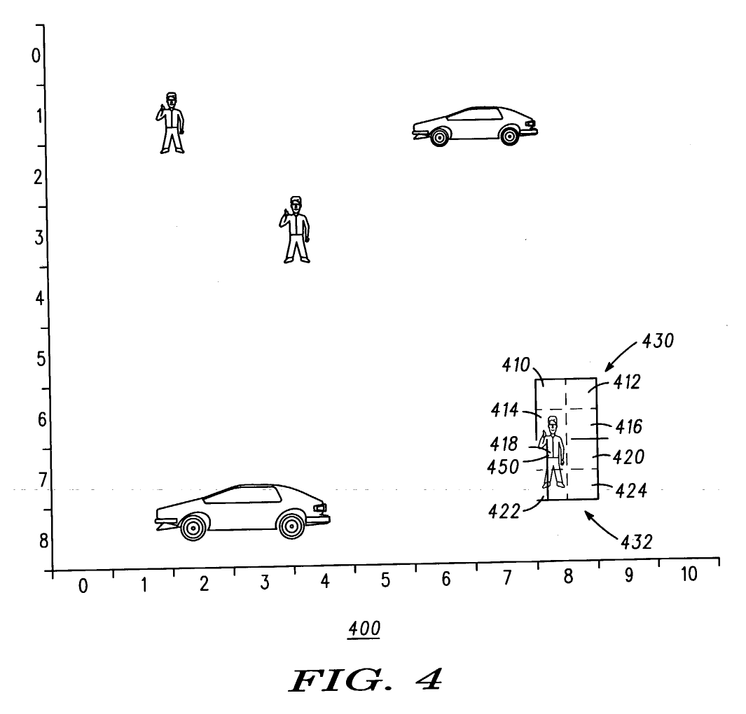

FIG. 4 shows a frame 400 of the image sequence. The frame contains a number of objects, of which object 450 has been identified by segmentation means 322 as being of interest.

In the example shown in FIG. 4, there is only one selected object, person 450.

The object overlaps parts of each of blocks 414, 418 and 422. In accordance with the invention, blocks 414, 418 and 422 constitute ‘selected blocks’. Using the further definition of ‘selected macroblocks’, two macroblocks of this image frame constitute ‘selected macroblocks’. These are macroblocks 430 and 432, where macroblock 430 comprises blocks 410, 412, 414 and 416, and macroblock 432 comprises blocks 418, 420, 422 and 424.

The segmentation means 322 may operate under user control. In this case, a user is able to identify objects of interest using user interface means 324. Considering the example of an image sequence relating to a team sport such as soccer, a user might for example identify two players from a team of 11 players as two objects of interest in the image sequence. Data relating to the images of these two players would then be transmitted preferentially over a radio channel to the receiver.

Segmentation means 322 could however be arranged to identify an object of interest automatically. The object of interest might for example be the object in an image showing the greatest movement, or the first object to move. No intervention by the user would then be required to instigate preferential transmission of image data about such an object. This might be of particular interest for an ‘un-manned’ security surveillance camera.

The video encoder of FIG. 3 may achieve preferential transmission of data related to the selected objects in a variety of ways. Examples of these are listed as follows under points 1)-6):

1) The encoder 304 may be adapted to use a different quantisation value for some or all of the selected macroblocks than for other macroblocks. In particular, encoder 304 may be adapted to use a lower target quantisation value for selected macroblocks than the target quantisation value for macroblocks not containing selected blocks. A lower target quantisation value will ensure that most frames of the image sequence have finer detail transmitted for the selected object(s) than for the background. This thereby provides a receiver of the transmitted bitstream with an image quality that is usually higher for the object(s) than for the background.

Considering once more the example of an image sequence of a tennis match, the selected object might be a tennis player. Thus macroblocks that contain the player will be quantised with a lower target quantisation value than macroblocks that only contain the crowd or the court. A receiver therefore normally receives an image of the tennis player that shows higher resolution of the player than of the remainder of the scene.

Encoder 304 may then further be adapted to use one or more quantisation values for the selected macroblocks of a frame that are lower than the quantisation values used for other macroblocks of the frame. This would guarantee that the object(s) were transmitted with higher resolution than the remainder of the image, for every frame of the image sequence.

2). The encoder 304 may be adapted to not encode, for at least one frame, some or all of the macroblocks not containing selected blocks. This clearly lowers the priority of the macroblocks that do not show any part of the selected object(s). Even if these blocks change substantially from one frame to the next, they will still not be transmitted. A higher proportion of the bandwidth on the communication channel will then be available for macroblocks containing the selected object(s). Macroblocks containing the selected object(s) may therefore be sent, for example, at a lower quantisation than would otherwise be possible.

As a variation of this, the encoder 304 may be adapted to encode the selected macroblocks more frequently than macroblocks not containing selected blocks. For example, the encoder could encoded selected macroblocks n times more frequently than non-selected macroblocks. Here n could take an integer value, with, for example, a limit such as n<20, to ensure that some background is sent at least every 20^{th} frame.

As a further variation, encoder 304 may simply be adapted to not encode an entire frame, if the selected blocks of that frame do not require refreshing. This would mean that any frame in which the object(s) selected by segmentation means 322 did not change, would be skipped.

3). The encoder 304 and transmission circuitry 306 produce a signal for transmission that contains ‘re-synchronisation’ markers. The encoder 304 may therefore be adapted to provide extra re-synchronisation markers in the encoded bit-stream, in a manner that ensures that selected macroblocks are not lost due to channel transmission errors. This will make the selected macroblocks more robust to channel disturbances than data in the transmission signal relating to other parts of the image.

4). Encoder 304 may be adapted to increase the quantisation of any or all of the selected macroblocks if they have large motion vectors. This will allow these macroblocks to be transmitted more frequently. The result of this will be enhanced rendition of the motion of the selected object(s) in the image received by a receiver of the transmitted bitstream.

5). Encoder 304 may be further adapted to also select macroblocks in the current frame if the corresponding macroblocks in the immediately previous frame contained selected blocks, whereby transmission of these macroblocks of the current frame effectively replaces the background when an object moves around a scene in the image sequence.

If this were not done, then some of the techniques outlined under options 1-4 above might result in the receiver seeing a moving object clearly, but with no background at all at points where the object was immediately previously.

6). Encoder 304 may further comprise a rate control buffer 326, the encoder choosing the encoding rate of a block in dependence on the amount of data presently in the rate control buffer. This would therefore allow an adaptive encoding rate, with the encoding rate increasing at times of relatively little change in the scene.

Options 1)-6) above may be incorporated into the invention either alone or in combination. Taken individually, each can enhance the view of one or more objects in a received image, compared to the view obtainable with prior art encoders over the same bandwidth data channel. Notably, the extra prioritisation given by the invention to any selected object in an image sequence results only in payload bits in the transmitted data that a standard H.263 receiver can de-compress and decode. A video encoder containing the enhancements of the present invention therefore produces a transmitted signal that can be received by a receiver built entirely in accordance with the H.263 standard.

Typically, the video encoder of the invention forms part of a mobile or a portable radio. Similarly, the video encoder may form part of a mobile telephone.

The video encoder of the invention operates according to an inventive method.

The method of video encoding in accordance with the invention provides compression and encoding of frames of an image sequence for transmission. The method comprises segmenting a frame of an image sequence, thereby to recognise at least one object in the image sequence. In the example shown in FIG. 4, the object recognised is person 450.

The method further comprises dividing the frame of the image sequence into blocks. Blocks containing the at least one object are selected, to provide ‘selected blocks’. In the encoding step of the method, blocks of the image sequence are encoded into a single bitstream for transmission. The bitstream containing the encoded blocks is then transmitted. The transmission is such that blocks containing the at least one object are transmitted preferentially over other blocks.

Particular ways of achieving this preferential transmission of selected blocks are explained above in connection with FIG. 3, and will not be repeated here.

The method of video encoding outlined above may include the step of dividing the frame of the image sequence into macroblocks, each macroblock comprising chrominance and luminance information about a plurality of blocks. Macroblocks containing one or more selected blocks then constitute ‘selected macroblocks’. These selected macroblocks can then be preferentially encoded and transmitted.

The video encoder and method of the invention have been described with reference to a particular embodiment of the invention configured for operation in accordance with the H.263 standard. However, the preferential object encoding of the invention is applicable to other image sequence transmission systems, particularly ones in which bandwidth limits on the transmission link are a constraint.

Although FIG. 3 illustrates a circuit for implementing the invention, the invention also extends to a software implementation of the inventive principal. The circuitry of at least elements 304 and 322 of FIG. 3 may be implemented as an application specific integrated circuit (ASIC).

What we claim is:

1. A video encoder for compressing and encoding frames of a two dimensional image sequence for transmission, the video encoder comprising:
a segmentor for receiving only a two dimensional image sequence and identifying at least one object in a frame of said two dimensional image sequence;
a divider for dividing a frame of a two dimensional image sequence into blocks;
a selector for selecting blocks containing the at least one object, to provide selected blocks; and
a bitstream encoder for encoding blocks of the image sequence into a single bitstream for transmission; wherein the selected blocks containing the at least one object are included preferentially in the bitstream over other blocks.

2. The video encoder of claim 1 further comprising a transmitter for transmitting the bitstream containing the encoded blocks encoded by the bitstream encoder wherein the selected blocks containing the at least one object are transmitted preferentially over other blocks.

3. The video encoder of claim 1, wherein the divider is adapted to divide a frame of the image sequence into macroblocks, each macroblock comprising chrominance and luminance information relating to a plurality of blocks;
wherein macroblocks containing one or more selected blocks constitute selected macroblocks.

4. The video encoder of claim 3, wherein the encoder is adapted to use a different quantization value for some or all of the selected macroblocks than for other macroblocks.

5. The video encoder of claim 4, wherein the encoder is adapted to use a lower target quantization value for selected macroblocks than the target quantization value for macroblocks not containing selected blocks, thereby providing a receiver of the transmitted bitstream with an image quality that is usually higher for said object than for the background.

6. The video encoder of claim 4, wherein the encoder is adapted to use one or more quantization values for the selected macroblocks of a frame, the one or more quantization values used for the selected macroblocks being lower than the quantization values used for other macroblocks of the frame.

7. The video encoder of claim 3, wherein the encoder is adapted to not encode, for at least one frame, some or all of the macroblocks not containing selected blocks.

8. The video encoder of claim 3, wherein the encoder is adapted to encode the selected macroblocks more frequently than macroblocks not containing selected blocks.

9. The video encoder of claim 3, wherein the encoder is adapted to not encode an entire frame, if the selected blocks of that frame do not require refreshing.

10. The video encoder of claim 3, wherein the encoder is adapted to provide extra re-synchronization markers in the encoded bit-stream, thereby to ensure that selected macroblocks are not lost due to channel transmission errors.

11. The video encoder of claim 3, wherein the encoder is adapted to increase the quantization of any or all of the selected macroblocks if they have large motion vectors, thereby allowing these macroblocks to be transmitted more frequently and enhancing the rendition of the motion of the at least one object in the image received by a receiver of the transmitted bitstream.

12. The video encoder of claim 3, wherein the encoder is further adapted to also select macroblocks in a current frame if the corresponding macroblocks in the immediately previous frame contained selected blocks, whereby transmission of these macroblocks of the current frame effectively replaces the background when an object moves around a scene in the image sequence.

13. The video encoder of claim 1, wherein the encoder further comprises a rate control buffer, the encoder choosing the encoding rate of a block in dependence on the amount of data presently in the rate control buffer.

14. A mobile or a portable radio comprising a video encoder as claimed in claim 1.

15. A mobile telephone comprising a video encoder as claimed in claim 1.

16. A method of video encoding for compressing and encoding frames of an image sequence for transmission, the method comprising:
segmenting at least one frame of a two-dimensional video image sequence, thereby to recognize at least one object in the image sequence;
dividing the at least one frame of the image sequence into blocks;
selecting blocks containing the at least one object, to provide selected blocks;
encoding blocks of the image sequence into a single bitstream for transmission;
and transmitting the bitstream containing the encoded blocks; wherein the selected blocks containing the at least one object are transmitted preferentially over other blocks.

17. The method of video encoding of claim 16, wherein:
the step of dividing the frame of the image sequence into blocks comprises dividing said at least one frame of the image sequence into macroblocks, each macroblock comprising chrominance and luminance information relating to a plurality of blocks; wherein macroblocks containing one or more of said selected blocks constitute selected macroblocks.
